(19) United States
(12) Patent Application Publication
(10) Pub. No.: US 2010/0051716 A1
(43) Pub. Date: Mar. 4, 2010

(54) AUTOMATED SWITCH FOR LIQUID ADDITIVE INJECTION PUMP

(76) Inventor: Frank A. Walton, Ft. Worth, TX (US)

Correspondence Address: CARSTENS & CAHOON, LLP, P O BOX 802334, DALLAS, TX, 75380, US

(21) Appl. No.: 12/203,236

(22) Filed: Sep. 3, 2008

(51) Int. Cl. B05B 7/00

(52) U.S. Cl. 239/61

(57) ABSTRACT

The present invention discloses operation of a system for injecting a predetermined amount of a secondary fluid into a primary fluid stream. The system uses a liquid additive injection pump driven by a fluid powered motor that is driven by the primary fluid stream and can be selectively suspended by an automated switch mechanism. The automated switch mechanism comprises an actuator in communication with an actuating shaft and a fluid source. When the actuator is pressurized, an actuating shaft is displaced relative to a housing which either engages or suspends the fluid-powered motor.

### BACKGROUND OF THE INVENTION

1. Field of the Invention

The present invention relates to a liquid additive injection pump powered by a fluid motor driven by a primary fluid stream to which the liquid additive is to be injected. More specifically, the present invention relates to an automated switch which can engage a mechanism which selectively suspends injection of the liquid additive.

2. Description of Related Art

Fluid powered motors driving an additive injection pump connected to a source of fluid additives are typically installed in a line containing primary fluid under pressure. Typically, the primary fluid produces reciprocating movement of a piston assembly within a housing of the fluid motor. The fluid motor in turn reciprocates a piston within a cylinder of the additive injection pump to draw a quantity of secondary fluid into the primary fluid. Such devices have been applied to add medication to drinking water for poultry and livestock, treat water with additives, add fertilizer concentrate to irrigation water, or add lubricant or cleaning agents to water. In liquid additive injection pumps, such as that shown in commonly owned U.S. Pat. No. 6,910,405, reciprocating movement of the piston assembly is produced by a valve mechanism operable to establish a differential pressure. Specifically, opening and closing of the valve mechanism synchronized to the upstroke and down stroke positions of the piston assembly produces a pressure differential that moves the piston through its reciprocating cycle. Opening and closing of the valve mechanism is synchronized to the piston assembly by an over-center mechanism, which is actuated coincident with the piston assembly reaching the ends of its upstroke and down stroke positions. The over-center mechanism is spring-biased and serves to toggle the valve mechanism open and closed when an actuating shaft carried by the piston assembly engages stops that define the ends of its upstroke and down stroke excursions. The '405 patent discloses a novel on/off switch located on the motor that engaged the motor. The '405 patent discloses a cam mechanism attached to the actuating shaft. When the switch is in the off position, the reciprocating movement of the piston is arrested.

As discussed above, pumps such as the one listed above are beneficial for many uses including irrigation and providing drinking water for livestock. Often these applications are useful in remote places wherein they are inaccessible to electricity or a place wherein the application of electricity is impractical. Thus, one benefit of such pumps is that running electricity to said pumps is unnecessary as the driving force is provided by the primary fluid. However, because the pumps are often remotely placed, manually turning the pump on and off can prove difficult and or time consuming; it may be desirable to control a remotely placed pump from a location other than where the pump is located. Furthermore, because the switches are typically located at the pump, a person can only turn a single pump on or off at a time. There are several applications, such as a car wash, for example, wherein it may be desirable to control several pumps at a single time and without electric sensors or motors. Accordingly, the present invention provides a system whereby a liquid additive injection pump may be controlled remotely and without the need for electric sensors or motors.

### SUMMARY OF THE INVENTION

The present invention provides a system to inject a secondary fluid into a primary fluid. The system includes a fluid powered motor driven by a primary fluid stream. The fluid motor in turn drives a liquid additive injection pump to meter a secondary fluid. The fluid powered motor is provided with an automated on/off switch to suspend injection of the secondary fluid into the primary fluid by suspending operation of the fluid powered motor. The automated on/off switch comprises an actuator coupled with a fluid source and an actuating shaft, or any other apparatus to maintain primary and secondary fluids in communication. The actuator position of on or off is determined by the pressure of the fluid source. The actuator axially displaces the actuating shaft which either engages or suspends operation of the pump. When the actuator is in the on position, the actuating shaft is so axially displaced such that the fluid powered motor can engage and the secondary fluid is injected into the primary fluid stream. However, when the actuator is in the off position, the actuating shaft is so displaced such that the fluid powered motor is prohibited from engaging.

The pressure in the actuator can be controlled by controlling a valve positioned between the actuator and the pressurized fluid source. The valve can be remotely controlled to adjust the pressure within the actuator.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a cut-away illustration of one embodiment of a fluid motor powered liquid additive injection pump provided with an automated on/off switch which suspends reciprocating movement of the piston assembly of the fluid powered motor;

FIG. 2 is a side profile of the fluid powered liquid additive pump of FIG. 1 which illustrates the operation of a solenoid valve and the actuator;

FIG. 3 is a vertical cross-section illustration of the fluid motor portion of the liquid additive injection pump of FIG. 1 wherein the automated on/off switch mechanism is in the “on” position and there is normal operation of the reciprocating piston assembly of the fluid motor to the end of its upstroke excursion, which results in the valve mechanism being toggled by the over-center mechanism in one embodiment;

FIG. 4 is a vertical cross-section illustration of the fluid motor portion of the liquid additive injection pump of FIG. 1 wherein the automated on/off switch mechanism is in the “off” position and normal operation of the reciprocating piston assembly of the fluid motor is suspended; and

FIG. 5 is a vertical cross-section illustration of the fluid powered motor portion of the liquid additive injection pump of FIG. 1 wherein the automated on/off switch mechanism is in the “on” position and there is normal operation of the reciprocating piston assembly of the fluid motor to the end of the down stroke excursion.

### DETAILED DESCRIPTION

Several embodiments of Applicants' invention will now be described with reference to the drawings. Unless otherwise noted, like elements will be identified by identical numbers throughout all figures.

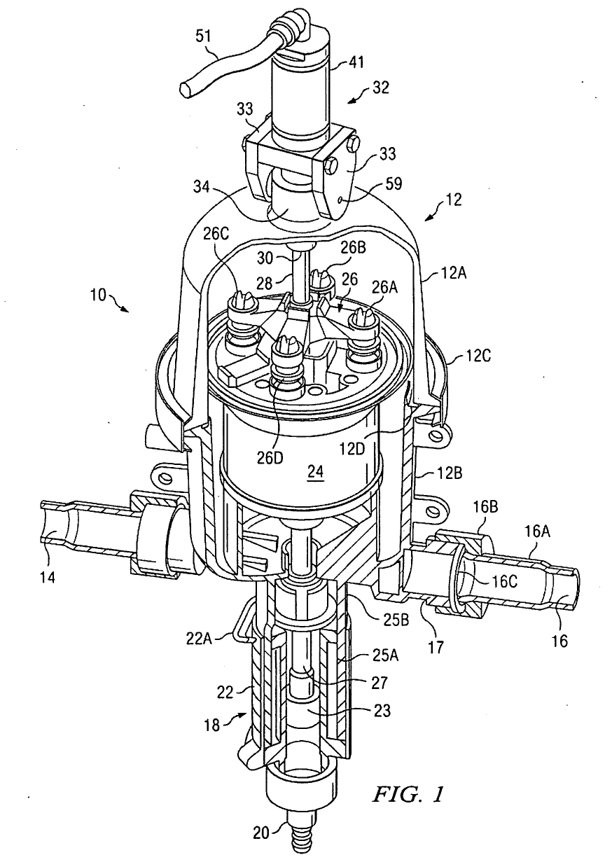

FIG. 1 is a cut-away illustration of one embodiment of a fluid motor powered liquid additive injection pump provided with an automated on/off switch which suspends reciprocating movement of the piston assembly of the fluid powered motor. It should be noted that while a pump utilizing a reciprocating movement will be described in detail, the invention is not so limited. The instant invention generally discloses a novel automated switch for controlling a fluid powered liquid additive injection pump. As such, many different types of motors and pumps may be utilized. For example, in one embodiment, rather than a reciprocating pump, the instant invention is applied to a turbine coupled to a centrifugal pump. In such an embodiment, the automated switch, when activated, couples the turbine powered by the primary stream to the pump which pumps a proportional amount of secondary liquid into a primary stream. This second embodiment is given as an illustration to the broad capabilities of the instant invention. Further, while reference is generally made to a switch comprising an actuator coupled to an actuating shaft, the instant invention is not so limited. The switch of the instant invention may comprise virtually any apparatus which maintains or prevents one fluid from being in communication with a secondary fluid by selectively engaging a fluid powered pump. For example, rather than an actuator and a shaft, a switch may comprise an actuator coupled to a valve which selectively engages a fluid powered pump. The examples and embodiments are given for illustrative purposes only and should not be deemed limiting.

Returning to FIG. 1, the fluid powered motor 10 is a nonelectric motor that is driven completely by the primary stream. In a preferred embodiment the primary stream is water. In the depicted embodiment, the pump is powered by an actuator shaft 28 which will be described in more detail below. The actuator shaft 28, sometimes referred to herein as the actuating shaft, is coupled to an actuator 41 which will be described in more detail below. The actuator shaft 28 may comprise a means for engaging the fluid powered motor by allowing the reciprocating pump a full upstroke as detailed herein as well as other means for selectively engaging the fluid powered pump by, for example, controlling a valve or the flow of the primary or secondary fluid or by otherwise inhibiting operation of the pump. Thus, while an actuator shaft 28 is discussed in reference to one embodiment, the instant invention may employ other apparatuses which selectively engage a fluid powered pump.

Still referring to FIG. 1, a housing 12, including a cover 12A and a lower body 12B, which are connected by a clamp 12C and an O-ring 12D, encloses the fluid powered motor components. An inlet conduit 14 provides for acceptance of a primary fluid stream and an outlet conduit 16 discharges the primary fluid stream. The outlet conduit 16 includes an adapter 16A and gasket 16C held with a nut 16B to an outlet port 17 in the lower body 12B. Coupled to fluid powered motor 10 is liquid additive injection pump 18. An inlet conduit having a fitting 20 provides for acceptance of a liquid additive. The liquid additive is drawn into pump 18 from an additive reservoir (not shown) and injected into the primary fluid stream. Metering of the liquid additive is adjustable by a ratio adjustment sleeve 22 and a locking pin 22A. The liquid additive injection pump 18 includes a dosage piston 23, which is movable within an inner cylinder 25A and an outer cylinder 25B by a connecting piston rod 27. The fluid powered motor 10 is coupled to the connecting piston rod 27 to drive the liquid additive injection pump.

The internal components of the fluid powered motor 10 within the housing 12 include a piston assembly 24. A valve mechanism 26 is carried on the piston assembly 24 and includes poppet valves 26A-26D. An actuator shaft 28 extends through the piston assembly 24 and is coupled to an over-center mechanism (not shown) that actuates the valve mechanism 26. Opening and closing of the valve mechanism 26 at the upstroke and down stroke positions of the piston creates a differential pressure within the housing 12 effective to produce reciprocating movement of the piston assembly 24. The internal components of the fluid powered motor 10 constitute what is termed a “differential pressure reciprocating piston assembly.”

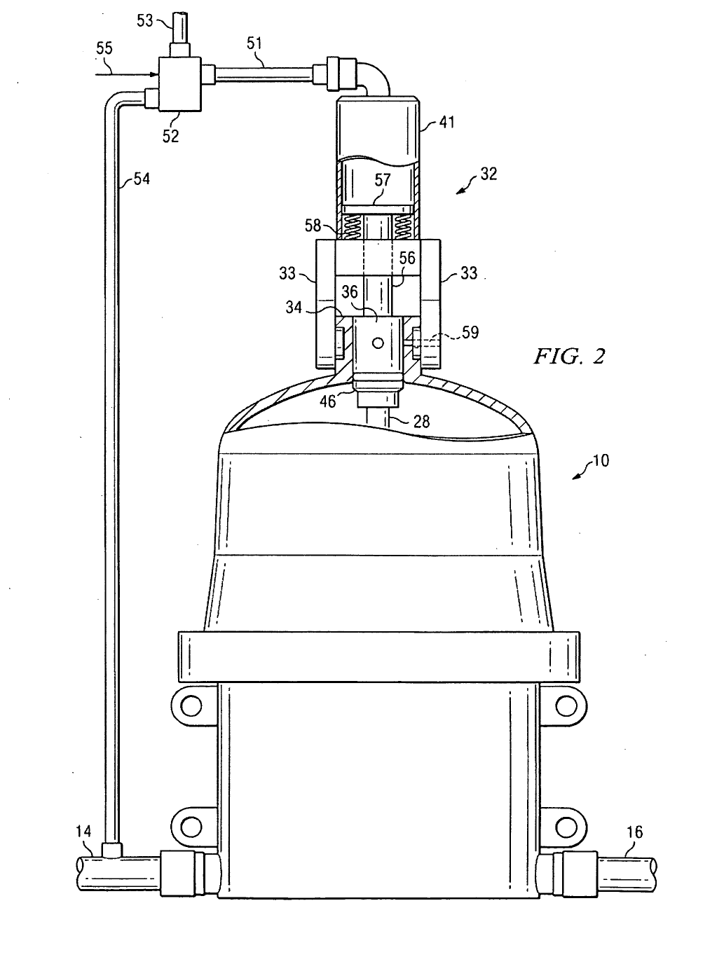

At the top of the housing 12 is an automated on/off switch mechanism 32. Such a mechanism is used to selectively suspend and engage operation of the fluid powered motor 10. The switch mechanism 32 as well as the actuator 41, in one embodiment, has two positions: an on position and an off position. As will be discussed in detail below, the position of on or off is determined by the pressure of the fluid source. Thus, both the actuator and the switch mechanism are in communication with the fluid source. A sleeve 34 extends from the top of housing 12. A shaft plug 36 (not shown) is axially movable relative to the sleeve 34. The shaft plug 36 is coupled to both the actuator shaft 28 and the actuator 41. The actuator 41 is further coupled to the coupling line 51. The actuator 41 is secured to the upper housing 12 via actuator brackets 33. As will be discussed below, the axial displacement of the actuator shaft 28 controls the operation of the fluid powered motor 10. Thus, the axial displacement of the actuator shaft 28 and the coupled shaft plug 36 provides visual indicia of whether the fluid powered motor 10 is on or off. Accordingly, in one embodiment the actuator brackets 33 comprise an indicator 59. As used herein an “indicator” is any visual indicia of the pump's operation status. In the embodiment shown, the indicator 59 is a hole in the bracket through which the displacement of the shaft plug 36 can be monitored. In such an embodiment, when aligned in the on position, for example, an indicator such as a green dot located on the shaft plug 36 will be visible through the indicator 59. Likewise, when aligned in the off position a red dot will be visible through the indicator 59. Other embodiments useful for indicating the status of the pump may also be employed. For example, a pressure gauge may be attached to the actuator 41, indicating whether the actuator is pressurized. Regardless of the embodiment employed, the goal is to provide visual indicia of the pump's status. The operation of the actuator 41 will next be discussed in reference to FIG. 2 below.

Referring now to FIG. 2, FIG. 2 is a side profile of the fluid powered liquid additive pump of FIG. 1 which illustrates the operation of one embodiment of the actuator 41 utilizing a solenoid valve 52. As will be discussed in detail below, a variety of valves may be employed. The valves are in fluid communication with both the actuator 41 and the fluid source.

It should be noted that many of the internal components of the fluid powered motor 10 are not shown in FIG. 2; only the parts necessary for the explanation of the automated switch mechanism 32 are shown. The fluid powered motor 10 is shown coupled to the actuator shaft 28. It can be seen that the actuator shaft 28 is coupled to a shaft plug 36. In one embodiment, the shaft plug 36 extends beyond the upper housing 12 of fluid powered motor 10. The shaft plug 36 is coupled and secured to the hanging shaft 56 which is coupled and secured to the actuator 41. The shaft plug 36 can be secured to the hanging shaft 56 by many methods known in the art including a spring pin. Within the actuator 41, the hanging shaft 56 is attached to the platform 57.

In the embodiment depicted, the actuator 41 has two extreme positions. In the first extreme position, the actuator 41 is in its natural state and does not apply any downward force. It can be seen that springs 58 provide an upward force on the platform 57. The upward force, when not counteracted as described below, keeps the platform 57 elevated within the actuator 41. In so doing, the actuator shaft 28 is either raised slightly, or at the least is not pushed downward. As will be discussed in detail below, in one embodiment such an action or inaction, prevents the fluid powered motor 10 from engaging. Alternatively, in the second extreme position, a force is applied which lowers the platform 57 downward within the actuator 41. This force, which counteracts and overcomes the upward force provided by the springs 58, causes both the shaft plug 36 and the actuator shaft 28 to be moved downward relative to the fluid powered motor 10. As will be discussed in detail below, such an action allows the fluid powered motor 10 to engage. Because, in this embodiment, a force is needed to turn the fluid powered motor 10 to the “on” position, the switch can be considered a fail safe device. In other words, if an outside source disrupts the force applied within the actuator 41 which causes the fluid powered motor 10 to engage, the fluid powered motor 10 will cease to engage. It should be noted that while one embodiment is generally described wherein a downward force engages the fluid powered motor 10, the invention is not so limited. For example, in other embodiments it may be desirable that an upward force engage the fluid powered motor 10. Thus, while reference is generally made to the actuating shaft 28 being axially displaced downward relative to the housing 12 to turn the pump on, the opposite is true in some embodiments. For example, in some embodiments, the actuating shaft 28 is axially displaced upward relative to housing 12 to turn the pump on. The instant invention discloses an apparatus and method whereby the actuator 41 position of on or off is determined by the pressure of a fluid source and the resulting axial displacement of the actuator shaft 28. Again, in some embodiments the actuator 41 is pressurized to engage the pump whereas in other embodiments the actuator 41 is depressurized to engage the pump. References to one application should not be interpreted as limiting. Thus, while the instant invention generally discusses one embodiment wherein to turn the pump on the actuator 41 is pressurized and the actuator shaft 28 is displaced downward relative to housing 12, it should be appreciated that this discussion is for illustrative purposes only and should not be deemed limiting.

It should also be noted that, while the embodiment shown discloses springs 58 which are attached to the platform 57, the current invention is not so limited. Any arrangement which provides for both a first extreme position wherein the actuator shaft 28 does not engage the fluid powered motor 10 and a second extreme position wherein the actuator shaft 28 engages the fluid powered motor 10 will suffice.

In the embodiment shown, the coupling line 51 is in fluid communication with the actuator 41. The coupling line 51 is also in fluid communication with a three-way solenoid valve 52. The three-way solenoid valve 52, in the embodiment shown, has a supply port coupled to a high pressure supply line 54, and two outlet ports including the purge line 53 and the aforementioned coupling line 51. Thus, the pressure in the actuator 41 is adjusted by controlling the solenoid valve 52. Solenoid valves are well known in the art, and use an electric current to control the operation of the valve. In one embodiment when it is desired that the pump is “on”, the solenoid valve connects the high pressure supply line 54 with the coupling line 51. The pressure from the coupling line 51, i.e. the actuating fluid, acts upon the platform 57 within the actuator 41 and provides a downward force. Thus, in operation, there is positive pressure exerted on the platform 57. As stated above, in such an embodiment when in the “on” position, the actuating shaft 28 is displaced downward which engages the fluid powered motor 10. However, when it is desired to stop the pump, the pressure within the actuator 41 must be relieved or depressurized. To do so, the three-way solenoid valve is adjusted to couple the coupling line 51 with the purge line 53. This allows the pressure in the actuator 41 to be relieved and stops the pump. Thus, in the “off” position, the actuating shaft 28 is not displaced downward, and the fluid powered motor 10 is not engaged.

Preferably, the purge line 53 is open to atmosphere to allow the pressure within the actuator 41 to reach about atmospheric pressure. In a preferred embodiment the three-way solenoid valve 52 is a fail safe valve which couples the high pressure supply line 54 with the purge line 53 in the event of low or interrupted current. It should be noted that while the embodiment described comprises a three-way solenoid valve, other valves known in the art will also suffice. For example, rather than one three-way solenoid valve, a plurality of two-way solenoid valves may be utilized. It should be noted that while an embodiment has been described utilizing a solenoid valve, the invention is not so limited. Other valves, both manual and automated, may be successfully employed to control the pressure within the actuator 41. As has been discussed, and will be discussed in more detail below, these valves can be located at the pump or at a distance removed from the fluid powered motor 10.

The fluid within the high pressure supply line 54, i.e. the actuating fluid, may come from a variety of fluid sources. In a preferred embodiment, the high pressure supply line 54 is coupled with the primary stream. In one embodiment, the high pressure supply line 54 is an off shoot from the inlet conduit 14. Thus, in such an embodiment, the actuating fluid is the same fluid as the primary fluid. For example, in such an embodiment, if water is driving the fluid powered motor 10, then water is also providing the pressure necessary to allow the actuator 41 to engage or disengage the fluid powered motor 10. In other embodiments, the high pressure supply line 14 is coupled with other fluid sources such as air. As used herein, “air” includes air in the traditional sense, i.e. breathing air, as well as other known gasses, including but not limited to, carbon dioxide, nitrogen, and oxygen.

Automated valves, such as the solenoid valve 52 depicted, typically require an electric current to operate. Thus, in one embodiment the three-way solenoid valve 52 is coupled to an electrical source through wire 55. The wire 55 is also coupled to a control or switch (not shown) which controls the electric current running to the three-way solenoid valve 52. This control or switch can be located far from the fluid powered motor 10 so that the fluid powered motor 10 can be started from a great distance from the pump. Additionally, the switch or control can be controlled via a computer which is capable of operating several fluid powered motors 10 at one time and in a variety of ways. For example, for some uses, such as a car wash, it may be desirable to add different additives to a fluid stream in varying points in a car wash. A computer can start and stop different fluid powered motors 10 at different times to accompany the many different additives desired. A further benefit is that the only electrical component is the wire connected to the three-way solenoid valve 52, or other suitable valve.

In many situations it may be undesirable to have a wire and a current source close to the fluid powered motor 10. For example, if the fluid powered motor 10 is being used in either a car wash or a swamp, delivering current through a wire may be difficult or unadvisable. Further, often laying electric wire 55 across remote land can be prohibitively expensive. The present invention provides many ways to overcome this problem. First, the valve can be placed outside of the wet environment. For example, keeping with the car wash scenario, the valve can be located either in the control room of the car wash or outside of the car wash. Thus, the high pressure line 51 may be extended as necessary to allow the valve to be centrally located compared to the fluid powered motor 10. Again, this will also eliminate the necessity of having electric wires 55 running all the way to the fluid powered motor 10. As discussed above, often running electric wire 55 is very expensive. In many applications it may be less expensive or more practical to run longer pipes (both coupling line 51 and high pressure supply line 54) than electric wire 55.

Another option of eliminating the need for electric wire 55 is to couple the valve 52 to a separate power source such as a battery or other means. As used herein a “separate power source” includes any power source which is not coupled to an electric grid. For example, the power source may comprise a battery coupled with solar panels. The power source may further be coupled with a remote receiver which may be controlled remotely via a remote control. Likewise, the valve may be coupled and controlled by a remote control. Thus, a fluid powered motor 10 can be located in a remote location without access to electricity, and a user can turn the motor 10 on and off from a centralized location via remote control. Again, in such an embodiment the valve is controlled by a separate power source.

Regarding solenoid valves, there are a wide variety of solenoid valves, most of which can be employed with the current invention. While some solenoid valves require an electric current to remain open, others require an electric current to remain closed. Still other solenoid valves commonly referred to as direct acting solenoid valves only require full power for a short period of time when adjusting the valve and use only low power to maintain the valve in its adjusted position. These direct acting solenoid valves are especially helpful in embodiments utilizing a separate power source. A common problem with any application utilizing a separate power source is running out of power too frequently. Using a solenoid which conserves power and which requires minimal power to operate ensures that the separate power source has a sufficiently long life. It should again be noted, that while one embodiment has been described with solenoid valves, the instant invention can utilize a wide variety of valves. For example, in one embodiment the actuating fluid is air from an air tank. The automated valve located on the air tank, which is controlled remotely, pressurizes and depressurizes the actuator 41. In other embodiments, for example, in the car wash scenario, the valve is opened or closed by external forces such as the position of a car in the car wash. When the valve is opened, the actuator is either pressurized or depressurized. Those skilled in the art can appreciate the many ways the pressure in an actuator 41 can be adjusted to control the fluid powered motor 10.

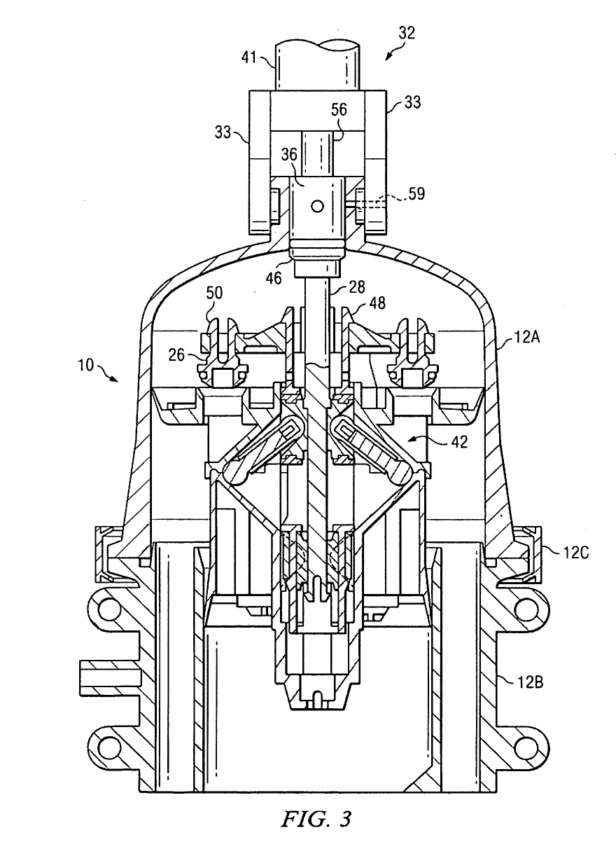

FIG. 3 is a vertical cross-section illustration of the fluid motor portion of the liquid additive injection pump of FIG. 1 wherein the automated on/off switch mechanism 32, and accordingly the actuator 41, is in the “on” position and there is normal operation of the reciprocating piston assembly 24 of the fluid motor 10 to the end of its upstroke excursion, which results in the valve mechanism 26 being toggled by the over-center mechanism 42 in one embodiment. Thus, in the “on” position the piston upstroke stop can assume its normal position and can be engaged when the piston 24 reaches its upstroke position. As seen in FIG. 3, the actuator shaft 28 includes a circumferential shoulder 46, which is aligned to be engaged by a collar extension 48 on the piston assembly 24. As will be appreciated, when the piston assembly 24 moves in the upstroke excursion, the inner collar extension 48 will the engage shoulder 46. Upon collar extension 48 engaging the shoulder 46, the valve mechanism 26 is moved to the closed position and the over-center mechanism 42 is triggered to toggle into a position that maintains closure of the valve mechanism 26. Upon closure of the valve mechanism 26, a differential pressure is created that causes the piston assembly 24 to begin moving in the down stroke excursion portion of its reciprocating cycle. In the position of the actuator shaft 28 shown in FIG. 3, the range of movement of the piston assembly 24 to the end of its upstroke permits the over-center mechanism 42 to fully toggle. As will also be appreciated, the over-center mechanism 42 forms a bi-stable device that establishes the valve mechanism 26 alternately in open and closed positions. With the actuator shaft 28 in the position shown in FIG. 3, normal operation providing reciprocating movement of the piston assembly 24 can continue.

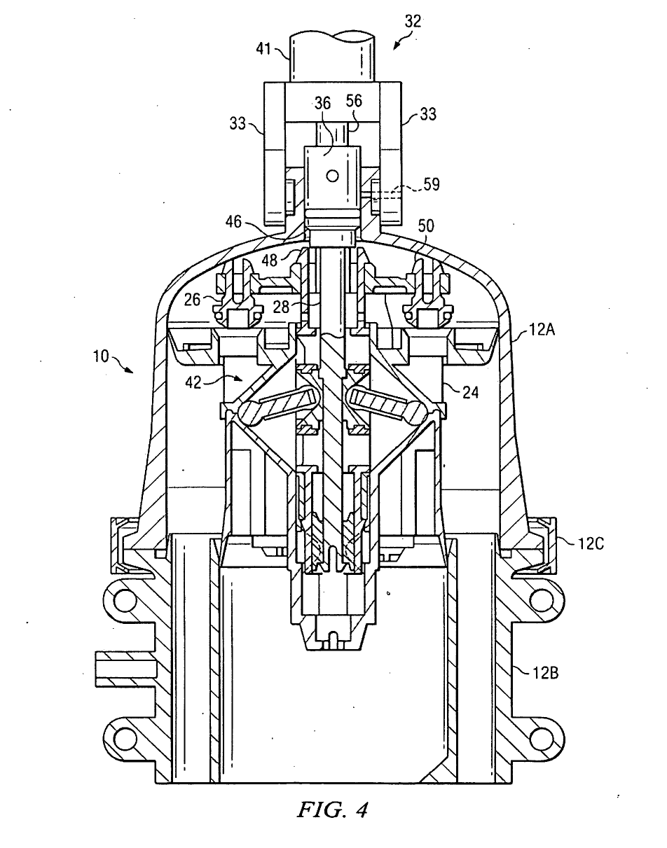

FIG. 4 is a vertical cross-section illustration of the fluid motor portion of the liquid additive injection pump of FIG. 1 wherein the automated on/off switch mechanism 32, and accordingly the actuator 41, is in the “off” position and normal operation of the reciprocating piston assembly of the fluid motor is suspended. As seen, the shaft plug 36, the hanging shaft 56, and the attached actuator shaft 28 are all displaced to the offset position. As will be appreciated, when the piston assembly 24 moves in the upstroke excursion, the inner collar extension 48 cannot engage the shoulder 46 because the outer collar extension 50 will engage the top of housing cover 12A ahead of time. As a consequence, the valve mechanism 26 will not close to create the differential pressure within the housing 12 that is necessary to move piston assembly 24 in the down stroke excursion portion of its reciprocating cycle. Also, although the over-center mechanism 42 will be partially moved, it will not fully toggle. With the actuator shaft 28 is the position shown in FIG. 4, normal reciprocating movement operation of the piston assembly 24 will not continue and liquid additive will no longer be injected into the primary fluid stream. Thus, when in the “off” position, the piston upstroke stop assumes an offset position and cannot be engaged when the piston 24 reaches it upstroke position. Upon activation of the automated switch 32 to the “on” position, however, the inner collar extension 48 will engage the shoulder 46 on actuator shaft 28. The valve mechanism will close and the over-center mechanism will complete toggling. The necessary differential pressure required for reciprocating movement of the piston assembly 24 will be re-established within the housing 12 and normal operation will resume.

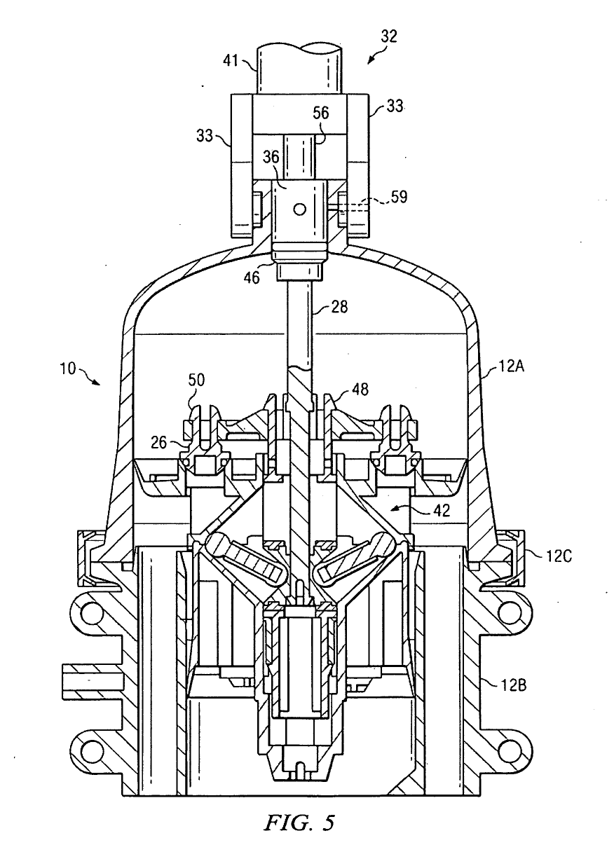

FIG. 5 is a vertical cross-section illustration of the fluid powered motor portion of the liquid additive injection pump of FIG. 1 wherein the automated on/off switch mechanism is in the “on” position and there is normal operation of the reciprocating piston assembly of the fluid motor to the end of the down stroke excursion. As will be noted, the valve mechanism 26 has the poppet valves closed in the seated position. Also, the over-center mechanism 42 is in the opposite bi-stable condition to that shown in FIG. 3.

The aforementioned method and system results in a fluid powered motor which can be remotely controlled. While the invention has been particularly shown and described with reference to a preferred embodiment, it will be understood by those skilled in the art that various changes in form and detail may be made therein without departing from the spirit and scope of the invention.

What is claimed is:

1. A system to inject a secondary fluid into a primary fluid, comprising:
a fluid powered motor driven by a primary fluid stream, said fluid powered motor comprising an actuating shaft;
a liquid additive injection pump driven by the fluid powered motor; and
an automated on/off switch mechanism coupled to the fluid powered motor to selectively suspend and engage operation of the fluid powered motor via said actuating shaft;
wherein said automated on/off switch comprises:
an actuator having an on position and an off position,
wherein said actuator is coupled to said actuating shaft and in communication with a fluid source; and
wherein the actuator position of on or off is determined by the pressure of the fluid source.

2. The system of claim 1 wherein when in the on position, the actuating shaft is axially displaced downward, engaging said fluid powered motor.

3. The system of claim 2 wherein the fluid powered motor comprises a housing enclosing a differential pressure reciprocating piston assembly that includes said actuating shaft which provides a piston upstroke stop during normal operation and wherein said automated on/off switch mechanism axially displaces the actuating shaft relative to the housing such that the piston upstroke stop assumes its normal position when the actuator is in the “on” position and can be engaged when the piston reaches its upstroke position, and such that the piston upstroke stop assumes an offset position when the actuator is in the “off” position and can not be engaged when the piston reaches its upstroke position.

4. The system of claim 1 further comprising a valve in communication with said actuator and said fluid source.

5. The system of claim 4 wherein said valve is a solenoid valve.

6. The system of claim 4 wherein said valve is further coupled to an electric source.

7. The system of claim 4 wherein said valve is coupled to a separate power source.

8. The system of claim 4 wherein said valve is coupled to a remote receiver.

9. The system of claim 4 wherein said valve is controlled via computer.

10. The system of claim 1 wherein said fluid is the primary fluid.

11. The system of claim 1 wherein said fluid is air.

12. The system of claim 1 further comprising an indicator.

13. The system of claim 1 wherein said switch is a fail safe device.

14. An improvement to a system to inject a secondary fluid into a primary fluid, wherein said system comprises:
a fluid powered motor driven by a primary fluid stream;
a liquid additive injection pump driven by the fluid powered motor;
wherein the fluid powered motor comprises:
(a) a piston movable within a housing between upstroke and down stroke positions;
(b) a valve mechanism establishing a differential pressure within the housing to produce movement of the piston;
(c) an over-center mechanism coupled to the valve mechanism to toggle the valve mechanism between open and closed positions;
(d) an actuating shaft coupled to the over-center mechanism, the actuating shaft including a piston upstroke stop that causes toggling of the valve mechanism at an upstroke position of the piston during normal reciprocating movement of the piston;
wherein said improvement comprises an automated on/off switch mechanism coupled to the fluid powered motor to selectively suspend and engage operation of the fluid powered motor, said automated on/off switch comprising:
an actuator having an on position and an off position,
wherein said actuator is coupled to said actuating shaft and in communication with a fluid source; and
wherein the actuator position of on or off is determined by the pressure of the fluid source.

15. The system of claim 14 wherein when in the on position, the actuating shaft is axially displaced downward relative to said housing, engaging said fluid powered motor.

16. The system of claim 14 further comprising a valve in communication with said actuator and said fluid source.

17. The system of claim 16 wherein said valve is a solenoid valve.

18. The system of claim 16 wherein said valve is further coupled to an electric source.

19. The system of claim 16 wherein said valve is coupled to a separate power source.

20. The system of claim 16 wherein said valve is coupled to a remote receiver.

21. The system of claim 16 wherein said valve is controlled via computer.

22. The system of claim 14 wherein said fluid is the primary fluid.

23. The system of claim 14 wherein said fluid is air.

24. The system of claim 14 further comprising an indicator.

25. The system of claim 14 wherein said switch is a fail safe device.

26. A method of suspending and engaging operation of a fluid motor powered liquid additive injection pump, said fluid motor powered pump having a housing enclosing a differential pressure reciprocating piston assembly that includes an actuating shaft providing a piston upstroke stop during normal operation, and wherein said actuating shaft is coupled to an actuator which is coupled to a fluid source in communication with an automated switch, said method comprising the steps of:
pressuring an actuator with a fluid; and
displacing the actuating shaft relative to the housing such that the piston upstroke stop assumes its normal position and said actuating shaft can be engaged when the differential pressure reciprocating piston assembly reaches its upstroke position.

27. The method of claim 26 wherein when said actuator is pressured, the actuating shaft is displaced downward relative to the housing.

28. The method of claim 26 wherein when said actuator is depressurized the actuating shaft is displaced upward relative to the housing such that the piston upstroke cannot be engaged when the differential pressure and reciprocating piston assembly reaches its upstroke position and the operation of the fluid powered liquid additive injection pump is suspended.

29. The method of claim 26 wherein said pressuring step comprises adjusting a valve located between said actuator and said fluid source.
